(19) United States
(12) Patent Application Publication
(10) Pub. No.: US 2010/0070986 A1
(43) Pub. Date: Mar. 18, 2010

(54) CD/DVD Insertable Cartridge and Player for Optical Data - Media Discs of All Sizes, Types, and Formats with Security Features

(76) Inventor: Michael Robert Thomas, N. Fort Myers, FL (US)

Correspondence Address: MICHAEL R. THOMAS INVENTING CONSULANT, 189 Evergreen Rd., NORTH FORT MYERS, FL, 33903, US

(21) Appl. No.: 12/535,931

(22) Filed: Aug. 5, 2009

Related U.S. Application Data
(60) Provisional application No. 61/097,316, filed on Sep. 16, 2008.

(30) Foreign Application Priority Data
Sep. 16, 2008 (US) 61097316

(51) Int. Cl. G11B 23/03

(52) U.S. Cl. 720/732; G9B/23.02

(57) ABSTRACT

The invention consists of a combination of products including a optical data-media discs encased in a plastic cartridge or unincased in larger diameter from 5.25″ to 9″ discs with standard size and oversize versions with a sliding plastic or aluminum spring loaded doors to exclude dust, dirt, physical damage, and white color to reduce heat absorption, etc. Cartridge protective doors including spring operated side sliding and end sliding opening dust covers and fixed clear lens view window. The oversized discs provide security through non-interchangeability with standard sized discs. Also, the use of various shapes and sizes of holes through the case allow security through exclusion as does the cartridge itself.

### DRAWING DESCRIPTIONS AND SPECIFICATIONS NUMBERED

FIG. 1 CD/DVD Plastic Cartridge Standard or Oversized Anti-Piracy (White Color for Non-Heat Absorption or Clear or Various Colors as Desired)

(1) Horizontal Sliding Door Closed Position

(2) Reader/Writer Head Cover Hole Sealed Position

(3) Anti-Piracy Permanent Solid Case (No Holes)

(4) 5″ or 5.5″ Size Case to Enclose CDs, DVDs, Re-Writable, and Blue Ray, Compact Discs (5″ Standard Size Case and 5.5″ New Security Size Case to Exclude Usage of Standard Size Cases)

FIG. 2 CD/DVD Plastic Cartridge

(1) Spring Loaded Read/Write Window Cover Open

(2) Cover Slot Open Position for Players Door Opener Insertion Tab

(3) Adjustable Locking Hole Cover (On/Off)

(4) Holes Various Sizes, Shapes, and Locations, for the Purpose of Player Drive Pin Insertions for the Purpose of Security by Excluding Cartridges Not having Matching Pin Locations, Sizes, or Shapes

FIG. 3 CD/DVD Plastic Cartridge with Removable CD

(1) Case Lock Pin Screw Type Lock/Unlock (4 Places per Case) Flat or Phillips Plastic Screw Head on Top

(2) Top Half of Case

(3) Bottom Half of Case

(4) Case Lock Removable Pin Holes Screw Type or Permanently Sealed Glue in Place (4 Places)

(5) CD, DVD, or Re-Writable Disc (Disc Size 4⅝″ to 7″ or 9″)

(6) Case Lock Permanently Sealed Glue in Place (4 Places)

FIG. 4 CD/DVD Plastic Cartridge with Opaque Plastic Sliding Cover

(1) Cartridge

(2) Hub Drive

(3) Disc

(4) Cartridge Side View

(5) Read/Write Head Slot (On One Side of Cartridge or Both Sides and in Different Reader/Writer Head Positions if Necessary)

(6) Read/Write Head Cover Slot with Angled Sides

(7) End View of Cover Opaque Plastic Slide Open and Lock Closed

(8) Player Drive Pin Insertion Hole for Retracting the Read/Write Head Slot Cover

(9) Dimple and Recess for Securing Cover in the Closed Position

FIG. 5 CD/DVD Cartridge with Clear Plastic Cover—Cartridge with Full Plastic Cover

(1) Top Half of Plastic Cover Clear Full Width and Length by ½ of the Casing Width

(2) Bottom Half of Plastic Cover Opaque Full Width and Length by ½ of the Casing Width

FIG. 6 CD/DVD Cartridge with Disc Side Sliding Cover

(1) Sliding Cover for Reader/Writer Head

(2) Cover Holes for Player Door Drive Pins

(3) Upward Projecting Round Tabs

(4) Angled Retaining Door Slide Groove

(5) Recessed Round Tabs for Corresponding Door Locking with Item 3

(6) Alternative Method for Door Operation Roughened Surface Thumb Slide

FIG. 7 CD/DVD Plastic Cartridge with Opaque Plastic Sliding Cover

(1) Cartridge

(2) Hub Drive

(3) Disc

(4) Cartridge Side View

(5) Read/Write Head Slot (On One Side of Cartridge or Both Sides and in Different Reader/Writer Head Positions if Necessary)

(6) Read/Write Head Cover Slot with Angled Sides

(7) End View of Cover constructed of Glass, Plexiglas or Lexan, Optical Plastic, or other Clear Material, Glued In-Place or Heat Sealed In-Place or Sliding Cover Opaque

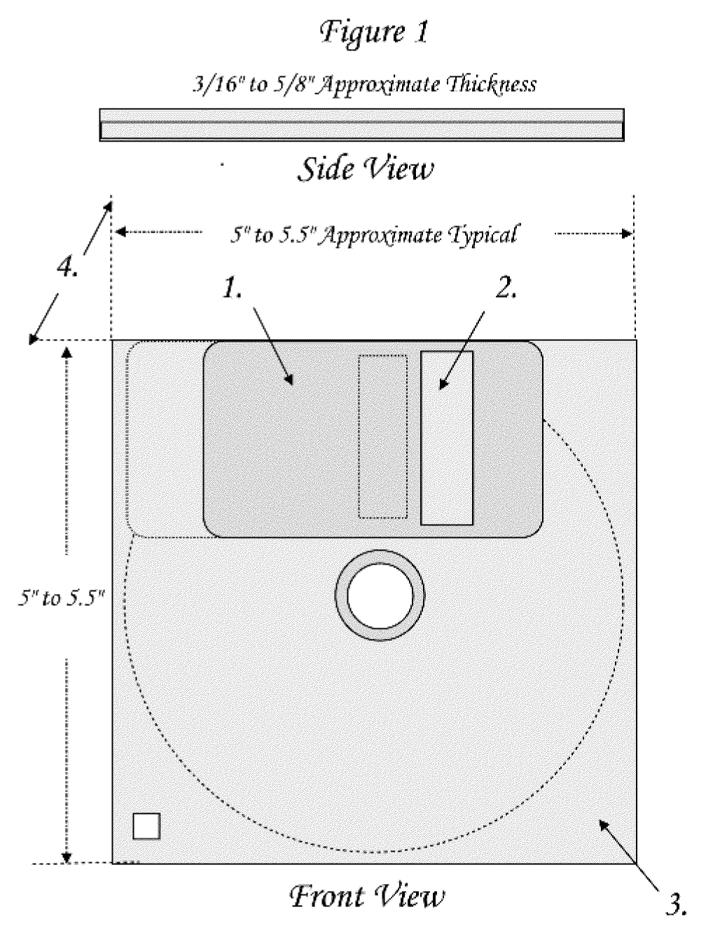

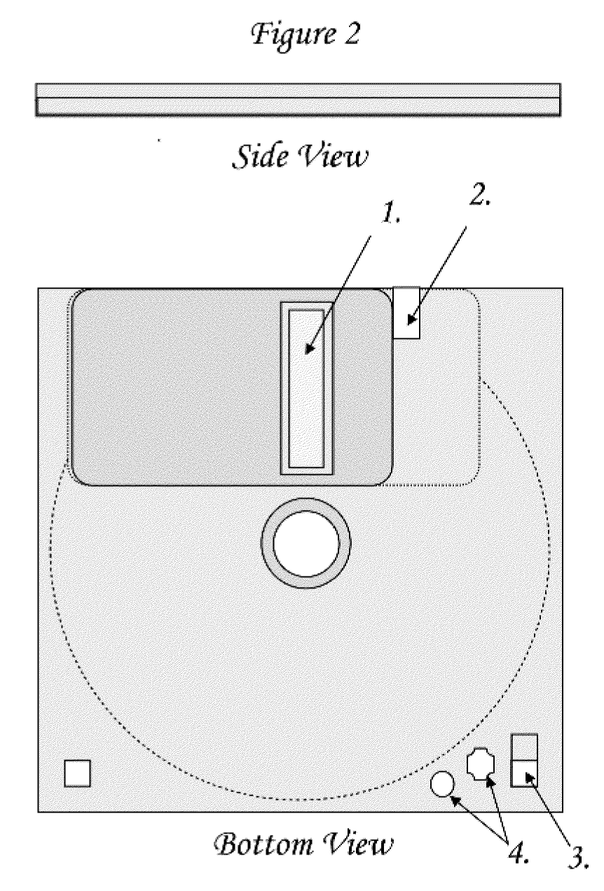

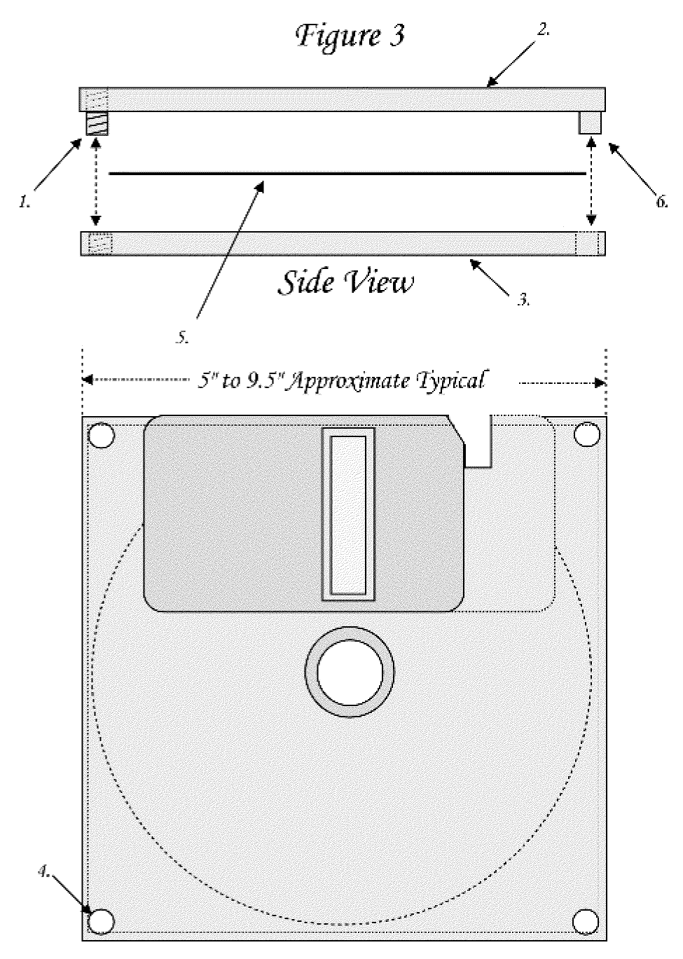

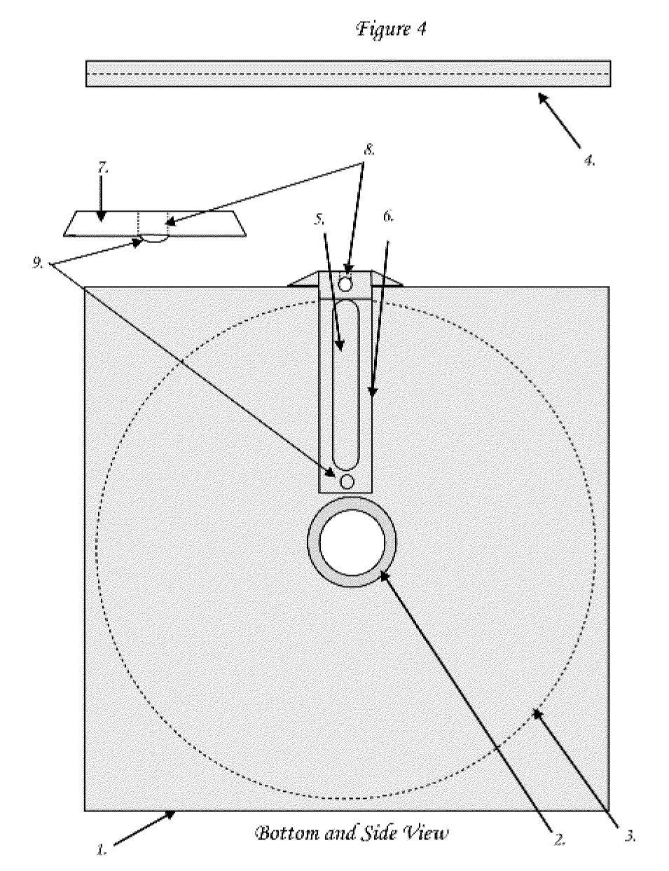

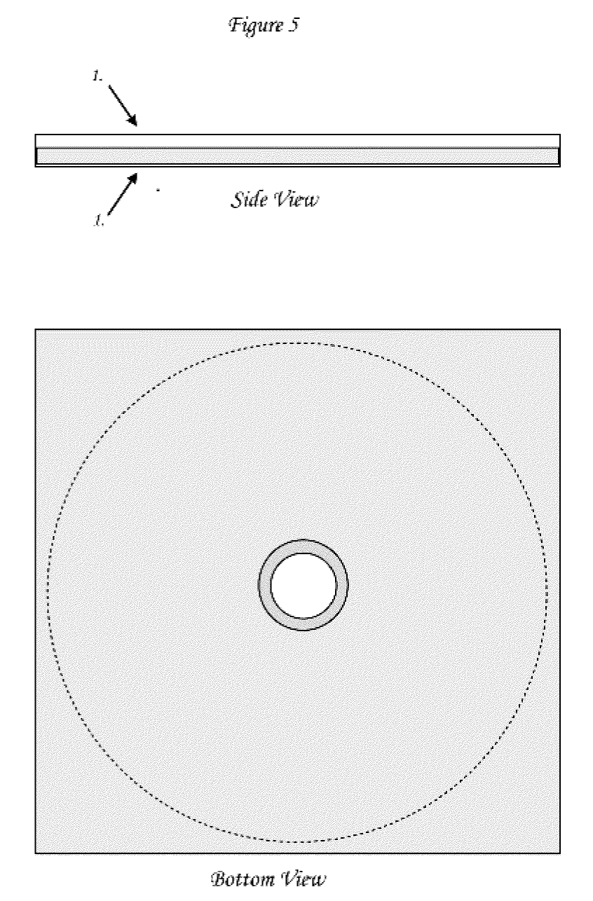

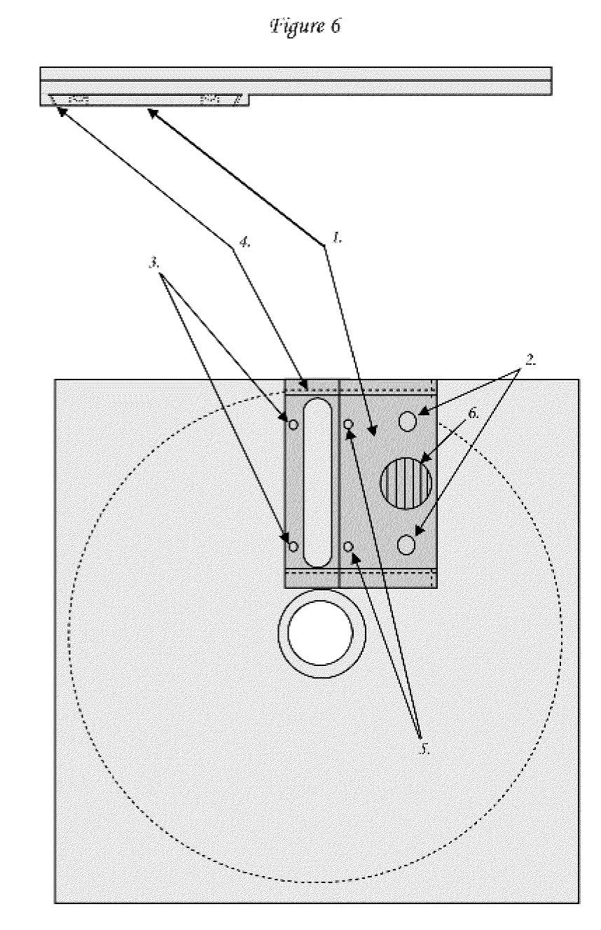

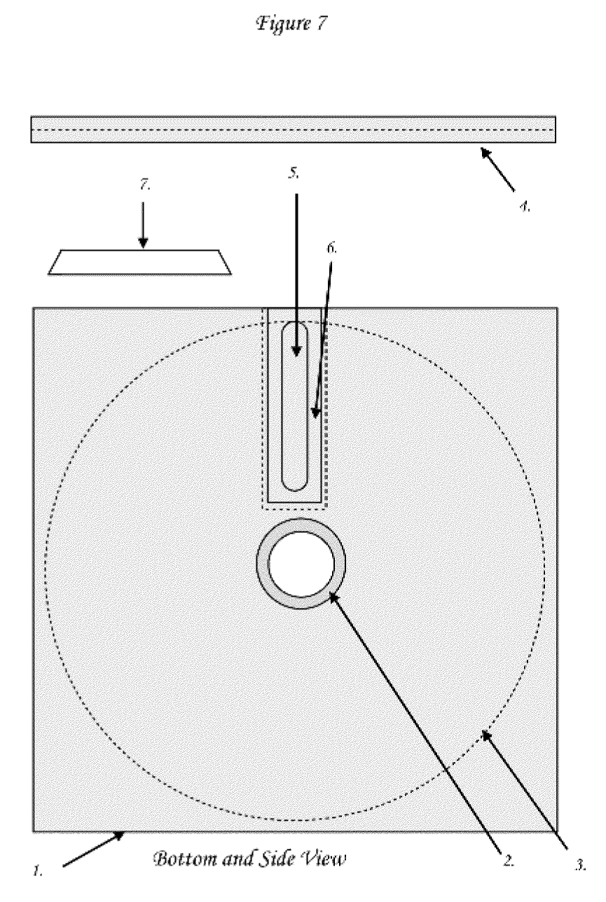

FIG. 1 Claims
Claimed is the invention of oversized 5.25″ CD/DVD discs in all presently available types and formats the purpose of improved security.
Claimed is the invention of sliding door cartridges for standard and larger diameter CDs and DVDs
FIG. 2 Claims
Claimed is the invention of spring loaded sliding view slot for optical head reader.
Claimed is the invention of multiple size, configuration, and position, holes in the cartridge for the purpose of security exclusion of pin switches in non-compatible drives.
FIG. 3 Claims
Claimed is the invention of glue together fasteners for security or standard tamper proof permanently sealed cartridges.
Item 5
Claimed is the invention of 5.25″ to 9″ recordable media discs for the purpose of increasing the recording capacity of the discs (All Types Encased and Uncased).
Claimed is the invention of oversized discs 5.25″ plus as a security feature through non-interchangeability with players that will accommodate no larger than 5.25″ discs (exclusion from usage by non-compatibility disc won't fit).
Claimed is the invention of 7¼″ size CD and DVD media data storage discs in all types for the purpose of a new security size to exclude the usage of a standard size disc.
Claimed is the invention of 9¼″ size CD and DVD media data storage discs in all types for the purpose of a new security size to exclude the usage of a standard size disc.
Claimed is the invention of the right to exclude the manufacturing of CD trays or drive units or cases capable of accepting the new oversized CD/DVD media data storage security discs.
Claimed is the invention of hole size shapes, sizes, and locations, on the disc as a method of excluding the usage of non-conforming discs for the purpose of security improvement to prevent computer usage or downloading or interchangeability with other machines to prevent the theft of media or data.
FIG. 4 Claims
Claimed is the invention of pin operated storage reader head view windows.
Claimed is the invention of Player Drive Pin Insertion Hole and Exterior Sliding Cover for Retracting the Read/Write Head Slot Cover.
FIG. 5 Claims
Claimed is the invention of permanently sealed or screw openable clear cover cartridges.
FIG. 6 Claims
Claimed is the invention of dual pin operated side sliding reader head cover and grooved track.
FIG. 7 Claims
Claimed is the invention of permanently fixed position clear window dust protective read/write head covers.

Purpose and Usefulness:

This new Cartridge will greatly improve the ability to protect intellectual materials from piracy and theft. Computers, business machines, and commercial units of all types will receive the benefit. In addition, the protective properties of the new Cartridge will improve the durability of the disc and prevent the damage and destruction of vital information that may have permanently destroyed otherwise.

There will a complete replacement player/writer for personal computers, free standing units, television sets, automobiles, home stereo, and all other uses currently in service. The usage of this system will be to exclude interchange ability with existing non-Cartridge players in order to improve Copy Wright and pirating of intellectual and royalty materials. The intellectual material of antipiracy protection through features incorporated within the new cassette.

The protective enclosure of the compact disc will protect the compact disc from children and damages caused by the environmental elements heat and dust and scratches caused by handling of using the disc. The new CD Cartridge will be particularly suited for commercial institutional applications where heavy usage is encountered. The anti-piracy features may only become commonly used in the event that manufactures and or legislation eliminate the manufacture of the present units.

The new cartridge combines features from existing cartridges with new features in order to create an improved product that will sell in a superior manner to its predecessors and give will consumers the option of reduced cost choices. The security features will help eliminate employee stolen CD/DVDs in commercial usages for the purposes of information theft and illegal usages.

What is claimed is:

1.) The invention allows for the usage of a compact discs, digital video discs, and multi-layer R/W discs, without removing them from their protective cases. These new diskettes will eliminate the need to remove the compact disc from a protective storage case before using. We claim the right to use or not use the snap together type (shown in FIG. 3) in order restrict the defeating of the anti-piracy features of the other shown drawings, also restricted should be, hinged, slotted, or drop in type diskettes and (not shown), opening/closing CD insert able/removable type diskette cases as shown in FIG. 3. The standard non-piracy CD will have the ability to be compatible will all types CD/DVD players.

2.) The usages will include compact discs, digital video, and multi-layer R/W discs. The multiple uses of the cassette in various types of CD player and writer units including; personal computers, laptop computers, automobile stereos, DVD players, home entertainment systems, and all other applications where compact discs are used. Restriction of usage by interchangeability and non interchangeability will allow manufacturers to produce machines that can only use a particular configuration of diskette in order to avoid pirating or in order to maintain privacy from the theft of information contained on the discs by the non interchangeability in other computers or particular business machines. Also, retail store security type anti-theft devices can be added to discourage thefts from buildings. Also, the use of the compact discs or the new diskette for the controlling of machine mechanical functions such as robotics and CNC machinery is also claimed.

3.) Anti-piracy features—The new CD diskette will have the following features in order to discourage Copyright and Royalty theft of multi-media intellectual material: Diskette case will have no holes for the insertion of a writer head exclusion pin and coupled with the restriction of manufactures licensed to produce the non-writable CD head players. Also, the addition of holes or non-holes may be used to exclude other CD manufactures from producing machines capable of using the discs. Also claimed herein is the concept of the infinite possibilities of the placement of holes or non placement of holes, large, small, hexagon, circles, squares, and the usage of view window closers of different types and descriptions in order to produce unique diskettes that are non interchangeable with existing diskettes in order to restrict the usage to a particular brand of machine or individual or limited number production groups of machines. Also claimed is the use of diskettes to operate machines or robotic equipment in the event that this has not previously been invented.
